(19) United States
(12) Patent Application Publication
(10) Pub. No.: US 2005/0247614 A1
(43) Pub. Date: Nov. 10, 2005

(54) Water treatment

(75) Inventors: Klaus Wiemer, Leichlingen (DE); Heinz Altenbach, Leverkusen (DE)

Correspondence Address: Michael Piontek, Suite 850, 221 N. LaSalle St., Chicago, IL, 60601, US

(73) Assignee: IMI Cornelius (UK) Limited

(21) Appl. No.: 10/842,090

(22) Filed: May 10, 2004

(51) Int. Cl. C02F 1/32

(52) U.S. Cl. 210/198.1; 210/748; 422/186.3

(57) ABSTRACT

A water treatment unit for a drinks dispenser has a flow passage and a UV light source arranged to irradiate water flowing through the flow passage to control levels of bacteria in the water at the point of dispense. The flow passage and light source are located in a housing that reflects the UV radiation towards the flow passage and absorbs heat emitted by the light source. An air inlet at the inlet end of the flow passage allows water to drain from the flow passage between dispenses and a cover at the outlet end of the flow passage prevents contamination of the flow passage by human contact.

### FIELD OF THE INVENTION

This invention relates to water treatment and in particular to the treatment of water with UV (ultra-violet) radiation. The invention has particular application to a water treatment unit for a drinks dispenser.

### BACKGROUND OF THE INVENTION

The quality of potable water for human consumption is regulated to control permissible levels of bacteria or other potentially harmful micro-organisms that could cause illness or other health problems when the water is consumed.

Drinks dispensers for dispensing potable water are well known and care is required to avoid conditions under which bacteria may grow and contaminate the potable water supplied to the dispenser.

Problems may arise due to the contamination of the outlet resulting from human contact causing growth of bacteria that may be picked up by the water dispensed from the outlet. This problem is increased by the presence of stagnant water in the outlet between dispenses allowing growth of bacteria in the water that is next dispensed.

### SUMMARY

The present invention has been made with these problems in mind and seeks to improve the quality of potable water dispensed from a drinks dispenser by the use of UV radiation.

More especially, the aim of the invention is to expose the water and the flow passage through which it is dispensed to UV radiation to kill bacteria in the water and to restrict growth of bacteria in the flow passage.

According to one aspect of the invention there is provided in or for a drinks dispenser for dispensing potable water, a UV treatment unit having an inlet for connection to a source of potable water, an outlet for dispense of potable water, a flow passage between the inlet and the outlet, the flow passage transmitting UV radiation, a UV radiation source for irradiating the flow passage with UV radiation, and an air inlet for draining the flow passage between dispenses of potable water.

Draining the flow passage between dispenses prevents growth of bacteria in stagnant water at the outlet.

According to another aspect of the present invention there is provided in or for a drinks dispenser for dispensing potable water, a UV treatment unit having an inlet for connection to a source of potable water, an outlet for dispense of potable water, a flow passage between the inlet and outlet, the flow passage transmitting UV radiation, a UV radiation source for irradiating the flow passage with UV radiation, and a protective cover for the outlet, the cover being separate from the outlet and having an opening through which potable water dispensed from the outlet can pass.

Protecting the outlet prevents contamination of the outlet by human contact with the outlet and arranging the cover separate from the outlet prevents bacteria on the cover growing back into the outlet.

According to yet another aspect of the present invention, there is provided in or for a drinks dispenser for dispensing potable water, a UV treatment unit having an inlet for connection to a source of potable water, an outlet for dispense of potable water, a flow passage between the inlet and outlet, the flow passage transmitting UV radiation, a UV radiation source for irradiating the flow passage with UV radiation, the UV radiation source comprising at least one UV lamp, and a combined heat sink and reflector enclosing the flow passage and UV lamp for absorbing heat from the lamp and reflecting UV radiation towards the flow passage.

Providing a housing to reflect the emitted UV radiation and to absorb the heat from the lamp improves the efficiency of the irradiation treatment and prevents the heat from the lamp being transferred to the dispensed water.

According to a still further aspect of the present invention, there is provided in or for a drinks dispenser for dispensing potable water, a UV treatment unit having an inlet for connection to a source of potable water, an outlet for dispense of potable water, a flow passage between the inlet and outlet, the flow passage transmitting UV radiation, a UV radiation source for irradiating the flow passage with UV radiation, and a sensor for actuating the UV radiation source in response to detection of a person in an active zone.

Arranging a sensor to actuate the UV radiation source in response to the presence of a person enables the UV treatment to be initiated before a dispense is actuated and further improves the effectiveness of the treatment.

The drinks dispenser incorporating the water treatment unit according to any of the foregoing aspects of the invention may be arranged to dispense still water and/or carbonated water and/or oxygenated water separately or in any combination.

The drinks dispenser preferably includes a filtration unit for treating the incoming water supply to remove bacteria with the UV irradiation at the outlet being used to reduce further the occurrence of bacteria in the dispensed water to low levels.

The UV radiation source may be arranged to be switched on permanently. Alternatively, the UV radiation source may be arranged to be switched on during dispense and to be switched off between dispenses.

Each of the foregoing aspects of the invention will now be described in more detail, by way of example only, with reference to the accompanying drawing.

### BRIEF DESCRIPTION OF THE DRAWING

FIG. 1 illustrates diagrammatically a water treatment unit according to the present invention.

### DETAILED DESCRIPTION OF THE EXEMPLARY EMBODIMENTS

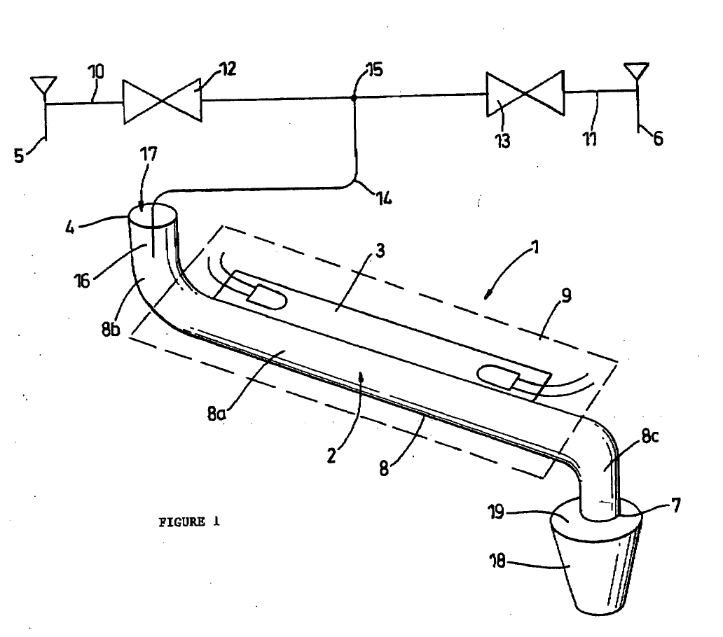

Referring to FIG. 1, there is shown a water treatment unit 1 for a drinks dispenser (not shown) for dispensing potable water.

The treatment unit 1 comprises an elongate glass tube 2 and a UV lamp 3 for irradiating the tube 2 with UV radiation. In this embodiment, the tube 2 is made of quartz glass but any other suitable material for transmitting UV radiation may be employed.

The tube 2 has an inlet 4 at one and for connection to sources 5,6 of still water or carbonated water and an outlet 7 for dispensing still or carbonated water.

Between the inlet 4 and outlet 7, the tube 2 provides a flow passage 8 of uniform cross-section.

The UV lamp is arranged to irradiate a linear centre section 8a of the flow passage 8 that in use is inclined at an angle of approximately 15° to the horizontal to assist draining the flow passage 8 as described later.

It will be understood, that the inclination of the flow passage 8 may be altered provided the inlet end is higher than the outlet end for draining the flow passage.

The centre section 8a leads to an inlet section 8b terminating in the inlet 4 at one end and to an outlet section 8c terminating in the outlet 7 at the other end.

In this embodiment, the inlet section 8b and outlet section 8c are arranged above and below the centre section 8a and extend substantially vertically. This assists drainage and ensures there are no pockets in the flow passage 8 where water could be trapped and retained when the unit 1 is drained. It will be understood, however, that the inlet section 8b and/or outlet section 8c may extend at an angle to the vertical.

The UV lamp 3 is arranged to extend parallel to and spaced from the centre section 8a of the flow passage 8. The lamp 3 may be of any suitable type and in this embodiment a 10W lamp with an arc length of approximately 200 mm is employed.

The UV lamp 3 and centre section 8a of the flow passage 8 are located in an housing 9 of sheet metal, for example stainless steel, having a polished internal surface that acts as a mirror to reflect UV radiation striking the internal surface back towards the centre section 8a. The internal surface may be flat or curved or any other suitable shape as desired. In this way, the UV irradiation efficiency of the unit 1 is increased.

The housing 9 also acts as a heat sink to absorb heat given off by the UV lamp 3. In this way build-up of heat within the unit 1 is prevented and the water that is dispensed is not heated to an appreciable extent as it flows through the unit 1.

Separate supply lines 10, 11 from the sources 5, 6 of still or carbonated water are connected via on/off solenoid valves 12, 13 respectively to a common delivery line 14 at a T-piece 15. The sources 5, 6 may be separate reservoirs for storing still and carbonated water in the drinks dispenser until required.

The sources 5, 6 may be connected to an incoming supply of potable water and the dispenser may include a filtration unit to filter the incoming supply to remove impurities. The filtration unit may also treat the water to comply with water quality regulations.

The source 6 of carbonated water may be a carbonator tank to carbonate and store the carbonated water until required. Alternatively, an in-line carbonator may be provided in the supply line 11 to carbonate the water. In this case, the sources 5, 6 may be a common reservoir.

The drinks dispenser may also include a cooler for dispense of chilled water and/or a heater for dispense of hot water according to customer selection via an appropriate interface.

The delivery line 14 is provided by a length of flexible tube having an outer diameter that is smaller than the inner diameter of the tube 2. In this way, the delivery line 14 can be connected to the unit 1 by pushing the end of the flexible tube into the inlet section 8b of the flow passage 8 to leave a gap 16 therebetween that provides an air inlet 17 for draining the flow passage as described later.

The outlet 7 is arranged to dispense still or carbonated water into a receptacle such as a glass or cup. A protective cover 18 in the form of a nozzle is provided with a through hole 19 aligned with the outlet 7 for dispensed water to flow through.

The cover 18 is mounted separately from the outlet 7 and prevents a customer touching the outlet 7. In this way transfer of bacteria or other contamination to the outlet 7 by physical contact with the outlet 7 is prevented. The hole 19 is sized so that water dispensed from the outlet 7 can pass through without contacting the cover 18.

In use, a customer selects dispense of still or carbonated water via an appropriate interface (not shown) on the drinks dispenser. The solenoid valve 12, 13 for the selected drink opens and water passes to the UV treatment unit 1 via the delivery line 14 and is dispensed into a receptacle placed under the outlet 7 via the cover 18.

In a modification, both valves 12, 13 may be opened simultaneously or in sequence to dispense a mixture of still and carbonated water. Such combination may be variable according to user selection of the desired ratio of still water and carbonated water.

A flow meter or timer (not shown) measures the volume of liquid to be dispensed and closes the solenoid valve 12, 13 at the appropriate time.

The air inlet 17 provided at the inlet end of the tube 2 allows air to enter and drain the water from the tube 2 automatically so that no water remains in the treatment unit 1 between dispenses.

The time at which the solenoid valve 12, 13 closes may be arranged such that the dispense is completed when the treatment unit 1 has drained.

The UV lamp 3 may be switched on permanently to irradiate the flow passage 8 to prevent any bacteria growing in the flow passage 8 between dispenses and to kill any bacteria in the water that is dispensed.

Typically, the water supply to the drinks dispenser will be potable drinking water having a low bacteria level to comply with local regulations and the treatment unit 1 further improves the quality of this water by killing a large proportion of any bacteria that may be present.

For example, in Germany, regulations require potable drinking water to have a maximum bacteria level of 100CFU (colony forming units) and we have found that the treatment unit 1 can be effective to reduce significantly such permissible bacteria levels by a relatively short exposure to UV radiation.

For example, in the above embodiment where the tube 2 has an internal diameter of 10 mm and a length of 250 mm, approximately 90% of bacteria in the water can be killed at a flow rate of 1.5 litres/minute providing an exposure time to the UV radiation of approximately 1 second.

In this way, acceptable dispense times can be obtained with greatly improved water quality. It will be understood, however, that the dimensions, flow rate and exposure time are exemplary only and any of these can be varied as may the power of the UV lamp to provide any desired performance of the unit 1.

The cover 18 prevents the outlet 7 being touched by the customer and is separate from the tube 2 so that bacteria on the cover 18 cannot grow back into the treatment unit 1. The hole 19 in the cover 18 is arranged so that any bacteria present is not picked up by the water that is dispensed to any significant extent.

The cover 18 may be coated with or contain or be made of an antimicrobial agent to reduce or prevent bacterial growth resulting from a customer touching the cover 18. For example, the cover 18 may be coated with silver or a plastics material containing an antimicrobial agent such as Microban®.

In the above described embodiment, the UV lamp 3 is permanently on so as to kill bacteria in the water during dispense and prevent growth of any bacteria in the tube 2 between dispenses which could otherwise by picked up by the water during the next dispense. For example air borne bacteria that may be drawn into the tube 2 when the unit 1 is draining at the end of a dispense.

It will be understood, however, that it may not be necessary for the UV lamp 3 to be on permanently. For example, when a customer selects a drink, the UV lamp 3 may be switched on before the dispense starts to irradiate and kill any bacteria in the empty tube 2.

The lamp 3 then remains on during the dispense to kill bacteria in the water and is switched off at the end of the dispense or a short time after the dispense is completed when the unit 1 has drained so as to kill any bacteria that may have entered the tube 2 on drain down. The length of time the UV lamp 3 is switched on before and/or after dispense may be set as desired.

In a modification (not shown), the UV lamp 3 may be switched on in response to detection of a customer in an active zone of the drinks dispenser. For example, a sensor may be arranged to sense the presence of a customer and switch the UV lamp 3 on.

The lamp 3 may be switched off if a dispense is not selected within a pre-determined period of time or after a selected dispense has been completed. The sensor may be a proximity sensor of any suitable type.

In periods of low use, the UV lamp 3 may be switched on periodically between dispenses to kill any bacteria that may be present in the tube 2 so that bacteria cannot grow to a level that would not be killed during the next dispense.

In the above described embodiment, a single UV lamp 3 is employed and the emitted UV radiation is reflected by the polished internal surface of the housing to improve the efficiency of the irradiation of the flow passage 8 and water flowing through the passage 8 during dispense.

In a modification (not shown), a plurality of lamps may be provided with the number of lamps switched on being varied according to the operating condition of the unit 1.

For example, between dispenses one lamp may be switched on permanently to provide a UV radiation level sufficient to prevent growth of bacteria in the empty tube 2.

During dispense, additional lamps may be switched on to provide a higher UV radiation level to kill bacteria in the water and switched off again when the dispense is completed.

In this way, the life of the lamps may be increased. Also the higher UV levels during dispense may allow faster dispense of the water without reducing the effectiveness of the unit 1 in killing bacteria in the water.

A sensor or other suitable device (not shown) may be arranged to detect if a UV lamp 3 is not working and to prevent dispense. A warning light or other device may be activated locally to indicate that a UV lamp 3 requires replacement or a signal may be transmitted to a remote service location.

Sensors or other suitable devices (not shown) may also be arranged to monitor other functions of the dispenser and to provide an appropriate indication of the state of the function being monitored. For example, lamp life or filter life may be monitored and a signal provided to indicate when replacement is required. Such signal may be transmitted to a remote service location and/or activate warning light or other device locally.

Other variations and modifications will be apparent to those skilled in the art and it will be understood that the invention covers treatment units having any feature or combination of the features disclosed herein.

The term bacteria used herein is intended to include bacteria, micro-organisms, microbes, germs and the like that can be killed by UV radiation and is to be construed accordingly.

The invention has been described in the exemplary embodiment with particular reference to a drinks dispenser for dispensing either still water or carbonated water or a mixture of still water and carbonated water. It will be understood however that the invention could apply to the dispense of other types of potable water such as oxygenated water.

A drinks dispenser according to the invention may be arranged for dispensing a plurality of different types of water either separately or as a mixture of two or more types as desired. Alternatively, a drinks dispenser according to the invention may be arranged for dispensing one type of water only. The invention may also apply to the addition of flavourings to the dispensed water, for example syrup or juice concentrates.

1. A UV treatment unit for a drinks dispenser for dispensing potable water, said unit having an inlet for connection to a source of potable water, an outlet for dispense of potable water, a flow passage between said inlet and said outlet, said flow passage transmitting UV radiation, a UV radiation source for irradiating said flow passage with UV radiation, and an air inlet for draining said flow passage between dispenses of potable water, wherein a protective cover is provided for said outlet, said cover being separate from said outlet and having an opening through which potable water dispensed from said outlet can pass without contacting said cover.

2. (canceled)

3. A water treatment unit according to claim 1, wherein a combined heat sink and reflector is provided enclosing said flow passage and UV radiation source for absorbing heat from said UV radiation source and reflecting UV radiation towards said flow passage.

4. A water treatment unit according to claim 3, wherein said combined heat sink and reflector comprises a housing of sheet metal having a mirror-like internal surface to reflect UV radiation towards said flow passage.

5. A water treatment unit according to claim 1, wherein a sensor is provided for actuating said UV radiation source in response to detection of a person in an active zone.

6. A water treatment unit according to claim 1, wherein said UV radiation source can be switched on permanently.

7. A water treatment unit according to claim 1, wherein said UV radiation source can be switched on during dispensing and switched off between dispensings.

8. A water treatment unit according to claim 1, wherein said UV radiation source comprises a plurality of UV lamps.

9. A water treatment unit according to claim 1, wherein said UV radiation source can vary the level of UV radiation.

10. A water treatment unit according to claim 9, wherein said UV radiation source provides a higher level of UV radiation during dispensing than between dispensing periods.

11. A water treatment unit according to claim 1, wherein said UV radiation source is arranged to irradiate a centre section of said flow passage.

12. A water treatment unit according to claim 11, wherein said centre section extends downwards from said inlet to said outlet at an angle to the horizontal.

13. A water treatment unit according to claim 12, wherein said centre section is inclined at an angle of around 15° to the horizontal.

14. A water treatment unit according to claim 12, wherein said centre section connects inlet and outlet sections that extend at a steeper angle to the horizontal than said centre section.

15. A water treatment unit according to claim 14, wherein said inlet and outlet sections extend substantially at right angles to the horizontal.

16. A water treatment unit according to claim 1, wherein said air inlet is provided at said inlet.

17. A water treatment unit according to claim 16, wherein said air inlet comprises a gap between said inlet and a delivery line received in said inlet.

18. A water treatment unit according to claim 1, wherein a filtration unit is provided upstream of said inlet for treating the incoming water supply.

19. A water treatment unit for a drinks dispenser comprises a flow passage having an inlet end and an outlet end, a UV light source arranged to irradiate water flowing through said flow passage to control levels of bacteria in the water at the point of dispense, said flow passage and light source are located in a housing that reflects said UV radiation towards said flow passage and absorbs heat emitted by said light source, an air inlet at said inlet end of said flow passage allows water to drain from said flow passage between dispenses, and a cover at said outlet end of said flow passage prevents contamination of said flow passage by human contact.

20. A water treatment unit according to claim 19, wherein said cover is separate from said outlet end and has an opening through which potable water dispensed from said outlet can pass without contacting said cover.

21. A UV water treatment unit for a drinks dispenser for dispensing potable water, said unit having an inlet for connection to a source of potable water, and outlet for dispense of potable water, a flow passage between said inlet and said outlet, said flow passage transmitting UV radiation, a UV radiation source for irradiating said flow passage with UV radiation, and an air inlet for draining said flow passage between dispenses of potable water, wherein a combined heat sink and reflector is provided enclosing said flow passage and UV radiation source for absorbing heat from said UV radiation source and reflecting UV radiation towards said flow passage.

22. A UV water treatment unit for a drinks dispenser for dispensing potable water, said unit having an inlet for connection to a source of potable water, and outlet for dispense of potable water, a flow passage between said inlet and said outlet, said flow passage transmitting UV radiation, a UV radiation source for irradiating said flow passage with UV radiation, and an air inlet for draining said flow passage between dispenses of potable water, wherein a sensor is provided for actuating said UV radiation source in response to detection of a person in an active zone.

23. A UV water treatment unit for a drinks dispenser for dispensing potable water, said unit having an inlet for connection to a source of potable water, and outlet for dispense of potable water, a flow passage between said inlet and said outlet, said flow passage transmitting UV radiation, a UV radiation source for irradiating said flow passage with UV radiation, and an air inlet for draining said flow passage between dispenses of potable water, wherein said UV radiation source can vary the level of UV radiation, and wherein said UV radiation source provides a higher level of UV radiation during dispensing than between dispensing periods.
